(19) United States
(12) Patent Application Publication
(10) Pub. No.: US 2008/0164050 A1
(43) Pub. Date: Jul. 10, 2008

(54) Regular Square Insulating Cable, Application of Such Regular Square Insulating Cable and Method for Manufacturing Such Regular Square Insulating Cable

(76) Inventors: Hiroyuki Kamibayashi, Wakayama (JP); Hiroshi Nagasaka, Wakayama (JP)

Correspondence Address: WENDEROTH, LIND & PONACK, L.L.P., 2033 K STREET N. W., SUITE 800, WASHINGTON, DC, 20006-1021, US

(21) Appl. No.: 11/886,038

(22) PCT Filed: Mar. 7, 2006
(86) PCT No.: PCT/JP2006/004841

§ 371 Date: Oct. 3, 2007

(30) Foreign Application Priority Data
Mar. 10, 2005 (JP) 2005-067601

(51) Int. Cl. H01B 7/02; H01B 7/00; B05D 5/12

(52) U.S. Cl. 174/119 R; 427/118

(57) ABSTRACT

A first insulating layer 1 is formed by electrodeposition coating on the surface of an outer circumference of a linear conductor m wherein the cross sectional shape thereof is substantially square, and further thereon, a second insulating layer 2 is formed by dipping. In the formation of the first insulating layer 1, swelling occurs in the first insulating layer at a corner portion of conductor m due to the electrodeposition characteristics of electrodeposition coating. The relative concavo-convex occurs on the surface of the layer 1 by the swelling. The concavo-convex is planarized by the second insulating layer formed in accordance with film-forming characteristics of the dipping, whereby an insulated square wire superior in voltage resistance and conductor space factor is obtained.

### TECHNICAL FIELD

The present invention relates to an insulated square wire, more particularly an insulated square wire capable of forming a coil at a higher conductor space factor than that of conventional products, use thereof and a production method thereof.

### BACKGROUND ART

In recent years, lightening and down-sizing of electronic equipment has been ongoing, along with which lightening and down-sizing of each part installed in electronic equipment has also been desired. As one of the parts for which this lightening of weight and miniaturization are required, a coil (winding) can be mentioned.

A coil is constituted by winding an insulated wire necessary times concentrically or helically in one or more layers. The insulated wire comprises a linear conductor having a predetermined cross-sectional shape and an insulating layer covering the surface of the conductor.

In order to achieve lightening and down-sizing of a coil while maintaining the properties of the coil, it is necessary to increase a conductor space factor as high as possible when forming a coil by winding an insulated wire.

Here, the conductor space factor means a ratio defined by [sum of conductor sectional area S/coil sectional area]×100[%], wherein S is a sectional area of a conductor part of one wire from among the wire cross-sections appearing on the cross-section of the coil. Unless otherwise specified, the “cross-section” of a wire is a cross-section formed by cutting the wire in a plane perpendicular to the longitudinal direction of the wire.

A higher conductor space factor means more wires can be wound in the same space as compared to one having a lower conductor space factor, which in turn means that down-sizing and lightening of coil is possible.

To improve conductor space factor of a coil, an insulated flat wire (wire with a flattened circular cross sectional shape, wire with a near rectangular cross sectional shape) is increasingly used as an insulated wire in recent years. More recently, an insulated square wire with a substantially square cross sectional shape of a conductor has been drawing attention, and further improvement in the conductor space factor is expected (JP-A-2001-291444 and JP-A-2002-307104).

However, the present inventors have studied the detail of the cross sectional shape (cross sectional shape of whole wire including an insulating layer) of conventional insulated square wires, and found that the improvement of the conductor space factor, which is the object of the insulated square wire, is not sufficient as explained below.

The problem is caused by the non-uniform layer thickness due to the method employed for forming an insulating layer (coating), which in turn renders the cross sectional shape of the whole insulated square wire vastly different from an ideal square.

In the following, the insulated square wire is also referred to as a “square wire”. While the cross sectional shape of the conductor of a square wire can be regarded a square in the art, i.e., “substantially square”, a term “square” is simply used as appropriate in the following explanation. In addition, a linear conductor having a square sectional shape and positioned at the center of the square wire is also referred to simply as a “conductor”.

In the production of a square wire, as a method of coating a surface of a conductor with an insulating layer, a dipping method (JP-A-7-216058 and JP-A-7-238225) and an electrodeposition coating method (JP-A-7-320573) are known.

FIG. 3(a) shows a sectional view of a square wire wherein an insulating layer is formed by dipping. Hatching is omitted.

When an insulating layer 12 is formed on the outer circumference of a conductor 11 by dipping, film-forming property characteristic of dipping appears and, of the surface of the conductor as a base, a flat portion thereof has a thicker insulating layer due to an influence of the surface tension. Accordingly, as shown in FIG. 3(a), the insulating layer 12 swells in the 4 flat plane portions on the outer circumference of the conductor 11, where a portion near the center thereof (part indicated with symbol p10 in the Figure) has the largest thickness t10, which, approaching a corner portion (part indicated with symbol p20 in the Figure), becomes thinner, and thickness t20 at a corner portion is the smallest. Thus, a cross sectional shape of the square wire as a whole becomes a circular shape or near circular shape.

As shown in the Figure, the thickness t20 of the insulating layer at a corner portion is a thickness measured at the apex of the square section of the conductor in the diagonal direction thereof.

When a coil is produced by winding a square wire having a circular cross sectional shape as a whole as shown in FIG. 3(a), the proportion of the sectional area of the insulating layer 12 to the coil sectional area and the proportion of the void occurring between the wires to the coil sectional area increase as shown in FIG. 3(b), and the conductor space factor cannot be increased.

Furthermore, when thickness t10 of the insulating layer on the flat portion is made thin in order to increase the conductor space factor, thickness t20 of the insulating layer at the corner portion becomes thinner beyond the tolerance limit and degrades the voltage resistance. Thus, thinning of an insulating layer by dipping has a limitation.

For forming an insulating layer by dipping, a method wherein a varnish having a smaller surface tension than usual is used, and a conductor immediately after immersion in the varnish is passed through a die having a square sectional shape and then baked is known. According to such method, as shown in FIG. 4, an insulating layer on a flat portion of the outer circumference of the conductor becomes more flat, thickness t11 becomes thinner, and the conductor space factor of the coil can be improved (not shown) as compared to the embodiment of FIG. 3.

However, in such dipping using a die having a square sectional shape, the square (small) of the cross sectional shape of the conductor and the square (large) of the cross sectional shape of the die need to be accurately aligned to match the diagonal lines during passage of the conductor through the die, which makes the production difficult. In contrast, in the embodiment of FIG. 3, since a die having a circular sectional shape free of directivity is used, alignment is relatively easy.

In the embodiment of FIG. 4, since thickness t21 of the insulating layer at each corner is thin, good insulation performance cannot be obtained for the difficulty of the production method.

On the other hand, FIG. 5 shows a sectional view of a square wire wherein an insulating layer is formed by electrodeposition coating. Hatching is omitted. When an insulating layer 12 is formed on the outer circumference of the conductor 11 by electrodeposition coating, electrodeposition characteristic of thicker insulating layer at a corner portion of the conductor appears since the electric fields are concentrated to the corner portion during the electrodeposition process. Accordingly, as shown in FIG. 5, the insulating layer 12 swells round at a corner portion of the conductor, showing the largest thickness at thickness t22. In contrast, the thickness t12 at the flat portion of the conductor becomes thin, forming concavo-convex on the surface of the insulating layer and the cross sectional shape of the square wire as a whole becomes what is called a dog bone shape.

When a coil is produced by winding such a square wire having a dog bone cross sectional shape (not shown), wasted space (dead space) is produced between wires since the insulating layer on the flat portion of the conductor is concave, and the conductor space factor of the coil cannot be increased.

When the thickness of the insulating layer at a corner portion is made thin in order to suppress a dog bone shape phenomenon, the insulating layer of the flat portion becomes exceedingly thin, which degrades the voltage resistance of the square wire.

As discussed above, it is difficult to increase the conductor space factor more than the conventional level while maintaining high insulation performance when any of dipping and electrodeposition coating is used for forming the insulating layer.

### DISCLOSURE OF THE INVENTION

The problem of the present invention is to provide a square wire capable of further increasing a conductor space factor of a coil while maintaining high insulation performance, and a production method thereof.

The present inventors have conducted intensive studies to solve the above-mentioned problem and, as a result, found that a dog bone cross sectional shape (namely, a dent of an insulating layer produced in a flat portion of a conductor) that occurs due to the electrodeposition characteristics is reduced by the swelling of the flat portion that occurs due to the film-forming characteristic of dipping by forming a first insulating layer by electrodeposition coating, and thereafter by forming a second insulating layer thereon by dipping, which makes the cross sectional shape of a square wire as a whole even nearer to a square without producing a thin portion which would impair voltage resistance, and have completed the present invention.

Accordingly, the present invention is characterized by the following.

(1) An insulated square wire comprising;

a conductor having a substantially square cross sectional shape,

a first insulating layer formed by electrodeposition coating on an outer circumference of the conductor, and

a second insulating layer formed by dipping on an outer circumference of the first insulating layer,

wherein, in a surface of the first insulating layer, swelling due to the electrodeposition characteristics of electrodeposition coating occurs at a corner portion of the conductor, and the concavo-convex which occurs due to the swelling of the surface of the first insulating layer is planarized by the second insulating layer formed according to the film characteristics of the dipping.

(2) The insulated square wire of (1), wherein

the first insulating layer is a layer formed by electrodeposition coating an outer circumference of the above-mentioned conductor with epoxy-acrylic water dispersion varnish, and

the second insulating layer is a layer formed by dipping coating a polyamideimide resin.

(3) The insulated square wire of (1), wherein the thickness of the first insulating layer at a corner portion of the conductor is 1.1-fold to 3.0-fold of the thickness of the first insulating layer at a flat portion of the conductor, and a total of the thickness of the first insulating layer and the second insulating layer at a corner portion of the conductor is 0.8-fold to 20-fold of a total of the thickness of the first insulating layer and the second insulating layer at a flat portion of the conductor.
(4) A coil obtained by winding an insulated square wire of any of the above-mentioned (1)-(3).
(5) A production method of the insulated square wire comprising a first step of forming a first insulating layer by electrodeposition coating on an outer circumference surface of a linear conductor having a substantially square cross sectional shape, and

a second step of forming a second insulating layer by dipping further thereon,

wherein, in the first step, at a corner portion of the conductor, swelling occurs in the first insulating layer due to the electrodeposition characteristics of electrodeposition coating, and in the second step, concavo-convex due to the swelling in a surface of the first insulating layer is planarized by the second insulating layer formed according to the film-forming characteristics of the dipping.

(6) The production method of the above-mentioned (5), wherein a liquid paint used for the formation of the first insulating layer in the electrodeposition coating is an epoxy-acrylic water dispersion varnish, and the second insulating layer formed by the dipping is a layer made of a polyamideimide resin.
(7) The production method of the above-mentioned (5) or (6), wherein the above-mentioned conductor is produced by cold wire drawing of a material made of tough pitch copper to give a wire having a substantially square cross sectional shape, and then annealing the wire.

### BRIEF DESCRIPTION OF THE DRAWINGS

FIG. 1 shows the production method of the present invention and a square wire obtained by the method. FIG. 1(a) shows a first insulating layer formed in the first step. FIG. 1(b) shows a second insulating layer formed in the second step, and shows a sectional structure of the square wire of the present invention.

FIG. 2 is a sectional view showing one embodiment of the coil of the present invention. In this drawing, the lower side of central axis X1 of the coil is not shown, and hatching is appropriately applied for the purpose of distinguishing regions.

FIG. 3 is a schematic diagram showing each section of a square wire wherein an insulating layer is formed by dipping, and of a coil using the same. FIG. 3(a) is a sectional view of one square wire, and FIG. 3(b) is a partially enlarged view of a cross-section of a coil wherein the square wire is wound on a bobbin B10. In this drawing, the lower side of a central axis X10 of the coil is not shown, and hatching is appropriately applied for the purpose of distinguishing regions.

FIG. 4 shows a section of a square wire wherein an insulating layer is formed under different dipping conditions.

FIG. 5 shows a section of a square wire wherein an insulating layer is formed by electrodeposition coating.

### BEST MODE FOR EMBODYING THE INVENTION

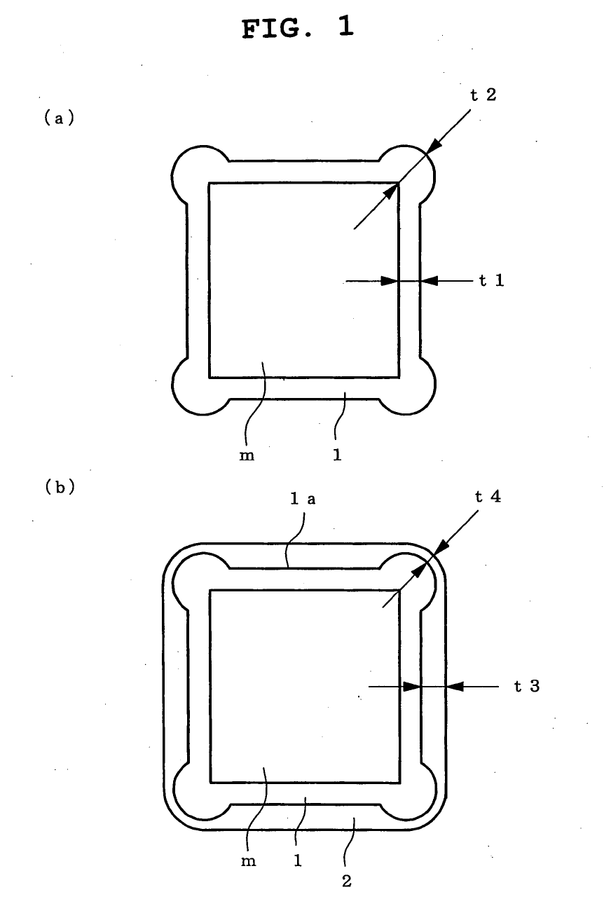

In the present invention, an insulating layer of a two-layer structure is formed, which comprises a first insulating layer by electrodeposition coating as a lower layer and a second insulating layer by dipping as an upper layer. With this constitution, a concave part 1a (a portion between the swellings) of a dog bone cross sectional shape which occurs in a first insulating layer 1 due to the electrodeposition characteristics as shown in FIG. 1(a) is filled with a second insulating layer 2 formed according to the film-forming characteristics of dipping as shown in FIG. 1(b), whereby the concavo-convex is planarized and the cross sectional shape of the square wire as a whole becomes more square.

In addition, a thin portion of the insulating layer which may impair voltage resistance or insulating property of the square wire does not occur at a corner portion or a flat portion of the conductor. This is because sufficient layer thickness is ensured by the electrodeposition characteristics of the first insulating layer at a corner portion of the conductor, and sufficient layer thickness is ensured by the film-forming characteristics of dipping of the second insulating layer at a flat portion of the conductor.

In the present invention, in other words, in terms of the cross sectional shape, a defect of electrodeposition coating is eliminated by a defect of dipping, and in terms of voltage resistance or insulating property, an advantage of electrodeposition coating and an advantage of dipping are both utilized.

By forming a coil using the square wire of the present invention, sufficiently good voltage resistance and high conductor space factor can be attained.

In the following, the production method of the present invention is explained, along with which the structure of the square wire of the present invention is simultaneously explained.

The production method of the present invention comprises at least a first step and a second step, as shown in the constitution described in the above-mentioned (5).

In the first step, as shown in FIG. 1(a), a first insulating layer 1 is formed by electrodeposition coating on the surface of the outer circumference of a linear conductor S having a substantially square cross sectional shape.

Conductor m may be any as long as it can be used as a core of a square wire. The cross sectional shape perpendicular to the longitudinal direction of the conductor is a square (substantially square). The ratio of the length of the adjacent two sides of the square is preferably about 0.8-1.2, particularly preferably 0.9-1.1, and the shape is preferably near perfect square.

While the length of each side of the square, which is the cross sectional shape of the conductor, is not particularly limited, for example, one having a side of about 0.02-2.0 mm can be mentioned as a widely used square, particularly, one having a side of about 0.05-1.0 mm is an important square wire in various industries.

As materials of the conductor, those conventionally-known as core materials of square wire may be used. For example, copper, aluminum, copper alloy, copper clad aluminum, nickel-plated copper, tough pitch copper, high purity copper (99.999 wt % Cu, 99.9999 wt % Cu), copper with silver plating, stainless and the like can be mentioned.

Of these materials, copper and copper alloy are important since they are most widely used as conductor materials of insulated wires. Particularly, tough pitch copper is a preferable material since it is the most general material and easily obtained.

The production method of the conductor is not particularly limited, and a known method in the technical field of a square wire may be used.

For example, in the method described in JP-A-2001-291444, a conductor having a substantially square section is produced by shearing a sheet material having a thickness equal to the one side length of the substantial square of the objective conductor having a substantially square section with a various kinds of severing means such as cutter roller, laser oscillator, wire and the like.

Further, in the method of JP-A-2002-307104, a conductor having a circular cross-section is passed through a reduction roll and rolled to give a band-like flat conductor having a thickness equal to the one side length of the objective conductor having a square sectional shape and, thereafter, this flat conductor is passed through a slit roller and cut into the width equal to the above-mentioned one side length, whereby a conductor having a substantially square cross-section is produced.

These production methods are only examples and other methods may be used for production. Moreover, if available, a ready-made conductor wire having a square cross-section may be used. Particularly, in a preferable production method, a material made of copper (particularly tough pitch copper) is processed by cold working to give a conductor having a square sectional shape and annealed to give a desired conductor wire. As a cold working technique per se for obtaining a conductor, a conventionally-known technique may be referred to.

As a liquid paint capable of performing electrodeposition coating for forming a first insulating layer, for example, aqueous dispersion varnish, solvent varnish and the like can be mentioned as preferable materials.

As aqueous dispersion varnish, aqueous epoxy-acrylic dispersion varnish can be mentioned.

The kinds of aqueous epoxy-acrylic dispersion varnish are not particularly limited, and a varnish obtained by dispersing a resin component made of appropriate acrylic resin containing an epoxy group in water (or hydrophilic solvent) using a stabilizer and the like as necessary, and the like can be used. As hydrophilic solvent, aqueous alcohol solution and the like can be mentioned.

As an example of acrylic resin containing an epoxy group, copolymer using at least 3 components, namely, component (a) made of acrylic monomer having a nitrile group and the like, component (b) made of acrylic monomer having an epoxy group and component (c) made of unsaturated organic acid having one or more double bonds capable of reacting with double bonds existing in either or both of component (a) and component (b), and the like can be mentioned.

As the above-mentioned acrylic monomer of component (a), for example, a compound represented by the formula (a):CH₂═C(R1)R2 wherein R1 is hydrogen atom or an alkyl group, R2 is a nitrile group, an aldehyde group or a carboxy ester group, and the like can be mentioned.

As the above-mentioned acrylic monomer of component (b), for example, a compound represented by the formula (b):CH₂═C(R3)R4 wherein R3 and R4 are each independently a hydrogen atom, an alkyl group, an amido group, an N-alkylamido group, an alkylol group, a glycidyl ether group or a glycidyl ester group, and at least one of R3 and R4 is a glycidyl ether group or a glycidyl ester group, and the like can be mentioned.

In preparation of the copolymer, one or more kinds of each component of the above-mentioned component (a), component (b) and component (c) can be used. From the aspect of heat resistance and the like of the obtained insulating layer, in the component which can be preferably used, R1, R2, R3 and R4 in the above-mentioned formulas (a) and (b) and of the unsaturated organic acid of component (c) have not more than about 30, preferably not more than 15, carbon atoms.

As preferable specific examples of component (a), acryronitrile, methacryronitrile, methyl acrylate, ethyl acrylate, propyl acrylate, butyl acrylate, methyl methacrylate, methethyl acrylate, propyl methacrylate, acrolein and the like can be mentioned. From the aspect of heat resistance and the like of the obtained insulating layer, particularly preferable component (a) has not more than 15 carbon atoms in total.

As preferable specific examples of component (b), glycidyl acrylate, glycidyl methacrylate, allyl glycidyl ether and the like can be mentioned.

As preferable specific examples of component (c), monobasic acid such as acrylic acid, methacrylic acid, crotonic acid, vinylacetic acid, α-ethylacrylic acid, β-methylcrotonic acid, tiglic acid, 2-pentenoic acid, 2-hexenoic acid, 2-heptenoic acid, 2-octenoic acid, 10-undecenoic acid, 9-octadecenoic acid, cinnamic acid, atropic acid, α-benzylacrylic acid, methyl atropic acid, 2,4-pentadienoic acid, 2,4-hexadienoic acid, 2,4-dodecadienoic acid, 9,12-octadecadienoic acid, dibasic acid such as maleic acid, fumaric acid, itaconic acid, citraconic acid, mesaconic acid, glutaconic acid, muconic acid, dihydromuconic acid, tribasic acid such as 1,2,4-butenetricarboxylic acid and the like can be mentioned. Particularly preferable component (c) includes acrylic acid, methacrylic acid, crotonic acid, α-ethylacrylic acid, maleic acid, fumaric acid and the like.

Preparation of the Above-Mentioned Copolymer can be appropriately performed, for example, by, a known polymerization such as emulsion polymerization, solution polymerization, suspension polymerization and the like. In this case, the amount of component (a) to be used is 1 to 20 mol, preferably 2 to 10 mol, more preferably 4 to 6 mol, per 1 mol of component (b). Further, the amount of component (c) to be used is 0.01 to 0.2 mol, preferably 0.03 to 0.1 mol, per 1 mol of the total of component (a) and component (b).

The above-mentioned copolymer can be prepared as a modification product of styrene or a derivative thereof, or diolefin. As the styrene derivative, a styrene wherein the phenyl group is substituted by one or more kinds of a nitrile group, a nitro group, a hydroxyl group, an amino group, a vinyl group, a phenyl group, a halogen atom, an alkyl group, an aralkyl group, an N-alkylamino group and the like, and the like can be mentioned.

As the above-mentioned halogen atom, chlorine, bromine and the like can be mentioned. As the alkyl group, methyl group, ethyl group, propyl group, butyl group and the like can be mentioned. As the aralkyl group, benzyl group, phenethyl group and the like can be mentioned. As the alkylamino group, methylamino group, ethylamino group, propylamino group and the like can be mentioned.

As preferable styrene derivative for modification, methylstyrene, ethylstyrene, divinylbenzene, chlorostyrene and the like can be mentioned. Further, as preferable diolefin, butadiene, pentadiene, methyl-butadiene and the like can be mentioned.

For modification, for example, one or more kinds of modifying agents are used in combination during copolymerization for the preparation of the above-mentioned copolymer. In this case, the amount of the modifying agent to be used is preferably not more than 2 mol as of styrene or a derivative thereof, and not more than about 1 mol, as of diolefin, per 1 mol of component (a). When an excess amount of styrene or a derivative thereof is used, the obtained insulating layer sometimes has poor flexibility. When an excess amount of diolefin is used, the obtained copolymer sometimes has low softening temperature.

The concentration of the epoxy-acrylic copolymer in the above-mentioned aqueous dispersion varnish is 0.1 to 10 wt %, preferably 0.3 to 5 wt %. When the concentration is less than 0.1 wt %, pinholes tend to occur, and when it exceeds 10 wt %, a uniform layer thickness is difficult to achieve.

In more detail, the coating step of the electrodeposition coating includes an electrodeposition step and a drying and baking step. For these electrodeposition techniques, and drying and baking technique per se, conventionally-known techniques may be referred to.

In the electrodeposition step, a conductor is immersed in water dispersion varnish by passing the conductor through an electrodeposition bath filled with the above-mentioned water dispersion varnish and the like, and a given voltage is applied in this state, whereby an electrodeposition film to be the first insulating layer is formed.

The voltage applied in this electrodeposition step is generally 1-150V in d.c. voltage, preferably 5-50V in d.c. voltage. Electrodeposition time is generally 1-60 seconds, preferably 2-10 seconds. As a temperature for the electrodeposition step, about 15° C. to 40° C. can be mentioned, and a preferable temperature is 20° C. to 30° C.

In the drying and baking step, an electrodeposition coated film is dried and baked using a conventionally-known dryer and a baking furnace and the like. By this processing, the water dispersion varnish becomes a varnish.

As the drying conditions, drying at a temperature of 80° C. to 120° C. for about 1-10 minutes can be mentioned. As the baking conditions, baking at a temperature of 180° C. to 240° C. for about 1-10 minutes can be mentioned.

The first insulating layer develops swelling in the corner portion due to the electrodeposition characteristics of electrodeposition coating, where the cross sectional shape thereof is a dog bone shape as shown in FIG. 1(a).

The actual value of thickness t2 of the first insulating layer 1 at the corner portion is not limited because it varies depending on the length of each side of the square, which is the cross sectional shape of the conductor, use of a square wire, the insulating property necessary for each use and the like. However, in a use often requiring a high conductor space factor, the general thickness is about 1 μm-50 μm, particularly about 3 μm-30 μm. The thickness of the first insulating layer of the corner portion is, as shown in FIG. 1(a), thickness t2 measured at the apex of the square section of the conductor in the diagonal direction thereof.

Similarly, the thickness t1 of the first insulating layer of the flat portion of conductor m is not limited for the same reason as for the above-mentioned thickness t2. However, the actual general value is about 1 μm-40 μm, particularly about 2 μm-25 μm.

The thickness of the first insulating layer of the flat portion is, as shown in FIG. 1(a), thickness t1 of the first insulating layer measured at the middle point of each side of the square sectional shape of conductor m.

When more accurate data of the layer thickness is necessary, any data processing method or statistical method may be employed such as an average thickness of the first insulating layer in the 4 corner portions or at 4 sides and the like.

The concavo-convex degree due to the swelling of the corner portion of the first insulating layer and concave relatively produced thereby in the flat portion is preferably within a suitable range in view of the planarization of the second insulating layer. To be specific, the thickness t2 of the corner portion of the first insulating layer is preferably about 1.1-fold to 3.0-fold, more preferably 1.5-fold to 2.5-fold, of the thickness t1 of the flat portion.

When t2 is smaller than 1.1-fold of t1, the swelling formed by dipping of the flat portion of the second insulating layer becomes greater than the swelling at the corner portion of the first insulating layer, where preferable cancellation does not occur. Conversely, when t2 is greater than 2.5-fold of t1, the concave part of the dog bone becomes too deep, where second insulating layer formed by dipping fails to fill the concave part flat, and a preferable square wire is not available.

As a method for controlling the concavo-convex degree of the first insulating layer surface to fall within the above-mentioned particular range in the electrodeposition step, for example, a method of controlling the ratio of t1 and t2 by adjusting or operating the application voltage (electrodeposition voltage) in the electrodeposition step and the like can be mentioned.

In the second step, as shown in FIG. 1(b), a second insulating layer 2 is formed on the first insulating layer 1 by dipping.

The dipping is a method including an immersion step where a conductor is immersed in liquid paint, a die passage step where the conductor is passed in a die to control the thickness of the coat, and a drying and baking step. The technique for each step of dipping is known by referring to a known technique.

The shape of the opening of the passage pore of die used for the die passage step may be circular. For coating to afford a uniform layer thickness of the flat portion, shape of the opening is preferably square (square die) because the layer thickness becomes highly accurate.

In the second step, to planarize the concavo-convex produced in the surface of the first insulating layer, the second insulating layer is preferably formed such that it becomes thin on the swelling of the first insulating layer and thick on the concave part, namely, selective filling in the concave part.

Such concavo-convex planarization can be achieved to a certain extent by performing the dipping in a conventional manner, which is attributable to the inherent property of dipping, [swelling of flat portion].

However, for optimal planarization corresponding to various concavo-convexes formed on the surface of the first insulating layer, it is preferable to minimize the thickness of the layer formed by one time dipping coating and repeat the dipping coating plural times to form multiple layers, whereby the accuracy of planarization can be improved.

The material of the second insulating layer may be any as long as the dipping can be applied, and a preferable material is polyamideimide resin.

A polyamideimide resin can be obtained, as shown in JP-A-7-216058, JP-A-7-238225, JP-A-7-268213, JP-B-44-19274 and the like, for example, by reacting trivalent or more polycarboxylic acid having an acid anhydride, group or a derivative thereof with aromatic diisocyanate in a polar solvent.

The trivalent or more polycarboxylic acid having an acid anhydride group or a derivative thereof is not particularly limited as long as it is trivalent or more polycarboxylic acid having an acid anhydride group capable of reacting with an isocyanato group, or a derivative thereof. In consideration of the heat resistance, cost and the like, trimellitic anhydride is preferable.

As the aromatic diisocyanate, 4,4′-diphenylmethane diisocyanate, tolylene diisocyanate, xylene diisocyanate, 4,4′-diphenylether diisocyanate and the like can be used. In addition, they can also be used in combination.

The amounts of the above-mentioned polycarboxylic acid or a derivative thereof and the aromatic diisocyanate to be used are preferably determined to achieve a ratio of isocyanate group to carboxyl group or a group derived therefrom and acid anhydride group of 1.5-0.7. To afford a resin having a high molecular weight, the ratio of isocyanato group to carboxyl group or a group derived therefrom and acid anhydride group is particularly preferably set to near 1.0. For the reaction, heating condensation is performed within a temperature range of 80° C. to 150° C. in the presence of a polar solvent while removing carbon dioxide, which is generated and liberated, from the reaction system. The reaction time is appropriately determined in view of the scale of batch and the reaction conditions to be employed. As the polar solvent, a chemically inert organic solvent, such as N-methyl-2-pyrrolidone, N,N-dimethylformamide, N,N-dimethylacetamide, dimethyl sulfoxide and the like can be used. The amount thereof to be used is preferably 1.0- to 3.0-fold (weight) of the polyamideimide resin to be produced.

The second insulating layer planarizes the concavo-convex of the surface of the first insulating layer by the swelling of the flat portion, which is attributable to the dipping characteristic, and its cross sectional shape becomes perfect rectangular as shown in FIG. 1(b).

By minimizing the thickness t4 of the second insulating layer 1, the curvature of the corner portion of the square wire as a whole approaches the curvature of swelling caused by electrodeposition coating, which is a large curvature (=small radius of curvature).

As the thickness t3 of the second insulating layer on the flat portion of the conductor m, a thickness greater than the step (≈t2−t1) of concavo-convex on the surface of the first insulating layer should be ensured, where the actual preferable thickness is about 1 μm-40 μm, particularly about 2 μm-30 μm.

The thickness of the second insulating layer on the flat portion is, as shown in FIG. 1(b), thickness t3 measured at the middle point of each side of the square sectional shape of conductor m.

When more accurate data of the layer thickness is necessary, as in the case of the first insulating layer, any data processing method or statistical method may be employed such as an average thickness of the first insulating layer in the 4 corner portions or at 4 sides and the like.

In addition, the radius of curvature of the corner portion can be sufficiently reduced to the level of swelling achieved by electrodeposition coating.

Moreover, swelling of the first insulating layer effectively protects the corner portion of the conductor and affords good insulation and the second insulating layer effectively protects the flat portion of the conductor and affords good insulation.

The total (t2+t4) of the first insulating layer thickness t2 and the second insulating layer thickness t4 at the corner portion of the conductor is preferably 0.8-fold to 20-fold, more preferably 1.0-fold to 1.6-fold, particularly preferably 1.0-fold to 1.2-fold, of the total (t1+t3) of the thickness t1 of the first insulating layer and the thickness t3 of the second insulating layer of the flat portion of the conductor.

Such uniformity of the layer thickness of the square wire cannot be achieved by independently applying electrodeposition coating or dipping in the conventional manner.

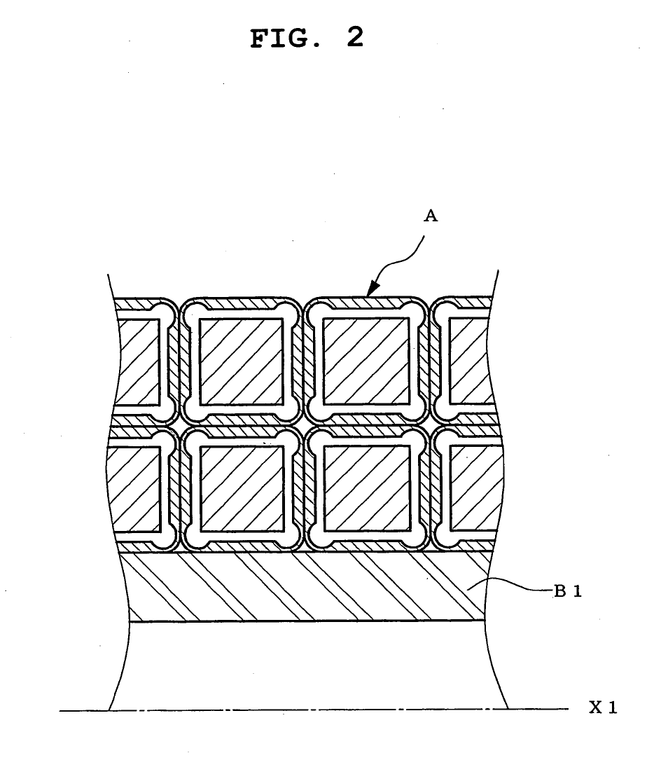

FIG. 2 is a sectional view showing one embodiment of the coil of the present invention. For explanation, the square wire A is wound in alignment in two layers on bobbin B1.

With such characteristics, the conductor space factor becomes high and the voltage resistance becomes good.

The coil of the present invention does not always require bobbin and core shown in the Figure and may take the form of various winding coils.

### EXAMPLES

### Example 1

In the present Example, using a copper wire having a square section of 0.5 mm on a side, the first insulating layer and second insulating layer were formed to prepare a square wire, and the characteristics thereof was evaluated.

First, in an electrodeposition step in a first step, as epoxy-acrylic water dispersion resin varnish, emulsion polymerization liquid obtained by reacting a mixture of acrylonitrile (4.5 mol), acrylic acid (0.8 mol), glycidyl methacrylate (0.5 mol), ion exchange water (750 g), sodium lauryl sulfate (7.0 g) and sodium persulfate (0.15 g) was used.

As the processing conditions of the electrodeposition apparatus, a conductor was used as anode and a stainless bar was used as cathode, the distance between anode and cathode was set to 3 cm, the electrodeposition voltage was set to 10V, electrodeposition time was set to 2 seconds, and the varnish temperature was set to 30° C.

Next, the conductor having an electrodeposition layer was dried at 100° C. for 10 minutes, and further baked at 200° C. for 5 minutes to form a the first insulating layer at the periphery of the conductor.

The thickness t2 of the first insulating layer at a corner portion was 20 μm and the thickness t1 at a flat portion was 15 μm.

Next, in the second step, polyamideimide resin (product No. HI-406) manufactured by Hitachi Chemical Co., Ltd. was applied by dipping, baked under the conditions of 200° C. and for about 10 minutes to form a second insulating layer.

At a corner portion of the conductor, the thickness t4 of the second insulating layer was 2 μm, on the other hand, at a flat portion of the conductor, the thickness t3 of the second insulating layer was 5 μm, and the total thickness (t1+t3) of the insulating layer at the corner portion was 1.1-fold of the total thickness (t2+t4) of the insulating layer at the flat portion.

### Comparative Example 1

Under the similar conditions to those of Example 1, only the first insulating layer was formed on the conductor by an electrodeposition coating method, and a square wire having the this the first insulating layer as an insulating layer was obtained.

The cross-section of this square wire is as shown in FIG. 5.

### Comparative Example 2

On the conductor, an insulating layer comprising polyamideimide resin was formed by dipping (including baking step). After dipping, this wire was passed through a die having a pore of a circular shape. The conditions for dipping step and the materials used are the same as Example 1.

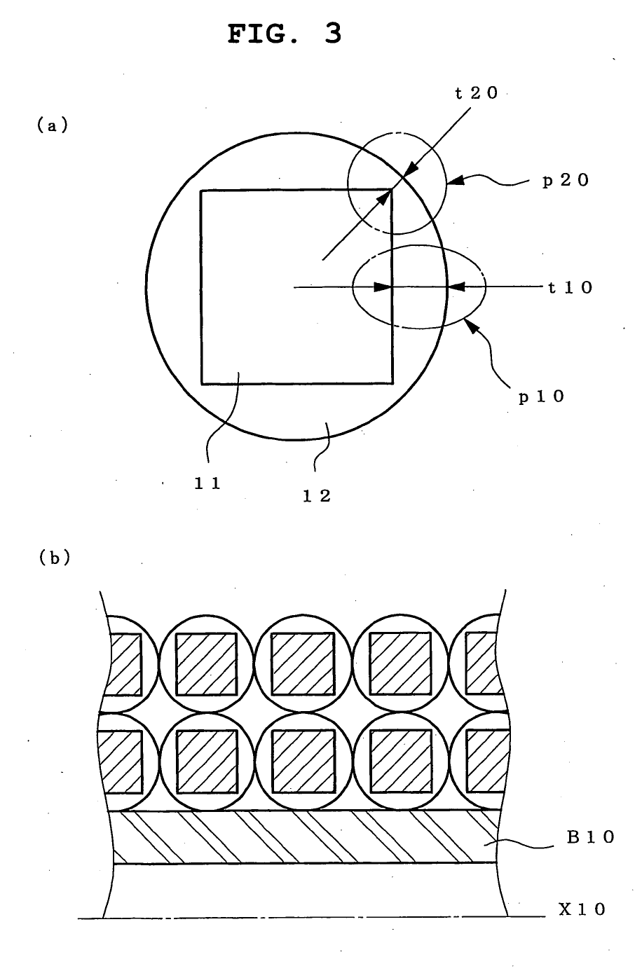

The cross-section of this square wire is as shown in FIG. 3.

### Comparative Example 3

An insulating layer comprising polyamide imide resin was formed to obtain a square wire under the conditions similar to those in the above-mentioned Comparative Examples except that the liquid resin used for dipping was adjusted so that the surface tension would become small and that after dipping, the wire was passed through a die having a square pore.

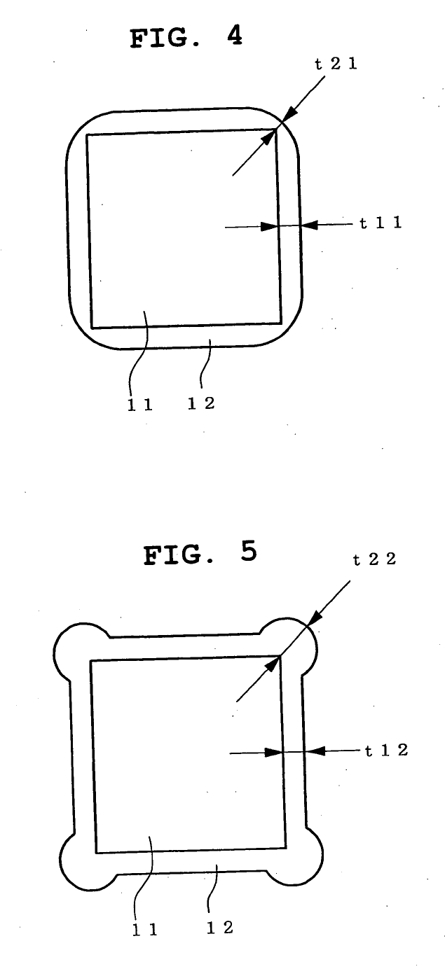

The cross-section of this square wire is as shown in FIG. 4.

The square wires obtained in Example 1 and Comparative Examples 1-3 were respectively measured for the dielectric breakdown voltage (kV), the radius of curvature (radius R of a roundness of a finished corner) on the outermost surface of the insulating layer at the corner portion when seen at the cross-section, and the conductor space factor of a coil prepared by regular winding.

The dielectric breakdown voltage was measured in accordance with 1 cm metal foil method specified in JIS C3003. The measurement results are shown in the following Table 1.

TABLE 1

| | | break- | | conductor |
|---|---|---|---|---|
| | | down | radius of | space |
| | | voltage | curvature | factor |
| | insulating layer | (kV) | (mm) | (%) |
| Example 1 | the first insulating | 3.5 | 0.03 | 71 |
| | layer: | | | |
| | electrodeposition | | | |
| | coated with water | | | |
| | dispersion epoxy• | | | |
| | acrylic varnish | | | |
| | second insulating | | | |
| | layer: dipping | | | |
| | coated with | | | |
| | polyamideimide resin | | | |
| Comparative | electrodeposition | 3.4 | 0.05 | 67 |
| Example 1 | coated with water | | | |
| | dispersion epoxy• | | | |
| | acrylic varnish | | | |
| Comparative | dipping coated with | 0.8 | 0.1 | 71 |
| Example 2 | polyamideimide resin | | | |
| Comparative | dipping coated with | 0.3 | 0.5 | 29 |
| Example 3 | polyamideimide resin | | | |

As is clear from the results shown in Table 1, comparing Example 1 with Comparative Example 1 comprising only electrodeposition coating, while the dielectric breakdown voltages are at the similar level, the square wire of Example 1 is superior in the radius of curvature and the conductor space factor.

Further, when comparing Example 1 with Comparative Example 2 comprising only dipping coating, the square wire of Example 1 is superior in all of the dielectric breakdown voltage, the radius of curvature at the corner portion and the conductor space factor.

When comparing Example 1 with Comparative Example 3, while the conductor space factors are at the similar level, Example 1 is strikingly superior in the dielectric breakdown voltage and the radius of curvature.

Thus, it was found that the square wire according to the present invention could form a coil simultaneously having higher insulation and higher conductor space factor than those of conventional coils.

### INDUSTRIAL APPLICABILITY

As mentioned above, in the square wire of the present invention, the first insulating layer formed by electrodeposition coating is used as a base, and the concavo-convex of the dog bone cross sectional shape occurring as a defect of the electrodeposition coating is planarized by covering with the second insulating layer formed by dipping, whereby the outer shape of the cross section as a whole becomes a near square. Moreover, the swelling at the corner portion of the dog bone shape obliterates the thin insulating layer at the corner portion, which is a defect of dipping. In other words, in the present invention, the respective defects of the two coating methods are combined to cancel each other.

As a result, the insulating layer as a whole has a cross sectional shape near a square at a uniform thickness over the entire circumference of the conductor.

When a coil is formed by regular winding of such square wire as shown in FIG. 2, the square wires adjacent to each other in the same layer and between the layers are closely adhered to each other to reduce the void, thereby affording a high conductor space factor.

Since the square wire of the present invention can form a coil having high conductor space factor, it is suitable as a coil requested to be light and small-sized, such as a voice coil for a loudspeaker and the like.

This application is based on a patent application No. 2005-067601 filed in Japan, the contents of which are incorporated in full herein by this reference.

1. An insulated square wire comprising;
a conductor having a substantially square cross sectional shape,
a first insulating layer formed by electrodeposition coating on an outer circumference of the conductor, and
a second insulating layer formed by dipping on an outer circumference of the first insulating layer,
wherein, in a surface of the first insulating layer, swelling due to the electrodeposition characteristics of electrodeposition coating occurs at a corner portion of the conductor, and the concavo-convex which occurs due to the swelling of the surface of the first insulating layer is planarized by the second insulating layer formed according to the film characteristics of the dipping.

2. The insulated square wire of claim 1, wherein
the first insulating layer is a layer formed by electrodeposition coating an outer circumference of the above-mentioned conductor with epoxy-acrylic water dispersion varnish, and
the second insulating layer is a layer formed by dipping coating a polyamideimide resin.

3. The insulated square wire of claim 1, wherein the thickness of the first insulating layer at a corner portion of the conductor is 1.1-fold to 3.0-fold of the thickness of the first insulating layer at a flat portion of the conductor, and a total of the thickness of the first insulating layer and the second insulating layer at a corner portion of the conductor is 0.8-fold to 20-fold of a total of the thickness of the first insulating layer and the second insulating layer at a flat portion of the conductor.

4. (canceled)

5. A production method of the insulated square wire comprising a first step of forming a first insulating layer by electrodeposition coating on an outer circumference surface of a linear conductor having a substantially square cross sectional shape, and
a second step of forming a second insulating layer by dipping further thereon,
wherein, in the first step, at a corner portion of the conductor, swelling occurs in the first insulating layer due to the electrodeposition characteristics of electrodeposition coating, and in the second step, concavo-convex due to the swelling in a surface of the first insulating layer is planarized by the second insulating layer formed according to the film-forming characteristics of the dipping.

6. The production method of claim 5, wherein a liquid paint used for the formation of the first insulating layer in the electrodeposition coating is an epoxy-acrylic water dispersion varnish, and the second insulating layer formed by the dipping is a layer made of a polyamideimide resin.

7. The production method of claim 5, wherein the above-mentioned conductor is produced by cold wire drawing of a material made of tough pitch copper to give a wire having a substantially square cross sectional shape, and then annealing the wire.

8. The production method of claim 6, wherein the above-mentioned conductor is produced by cold wire drawing of a material made of tough pitch copper to give a wire having a substantially square cross sectional shape, and then annealing the wire.

9. A coil obtained by winding an insulated square wire of claim 1.

10. A coil obtained by winding an insulated square wire of claim 2.

11. A coil obtained by winding an insulated square wire of claim 3.
